(19) United States
(12) Patent Application Publication
(10) Pub. No.: US 2025/0193181 A1
(43) Pub. Date: Jun. 12, 2025

(54) SYSTEM AND METHOD FOR MANAGING DEVICES IN VEHICLE SYSTEM

(71) Applicant: WOVEN BY TOYOTA, INC., Tokyo (JP)

(72) Inventors: Jonathan THAMBIDURAI, Palo Alto, CA (US); Sean NORRIS, Palo Alto, CA (US)

(73) Assignee: WOVEN BY TOYOTA, INC., Tokyo (JP)

(21) Appl. No.: 18/533,633

(22) Filed: Dec. 8, 2023

(51) Int. Cl. H04L 9/40

(52) U.S. Cl. CPC H04L 63/0876; H04L 63/0442; H04L 63/18

(57) ABSTRACT

Provided are a method, a system, and a device for managing one or more devices in a vehicle system. According to embodiments, the method may be implemented by at least one processor and may include: obtaining, from a first device, a message for requesting a service from a second device, wherein the message comprises information of an identity (ID) of the first device; determining, based on the ID of the first device, whether or not the first device is registered; based on determining that the first device is not registered, performing one or more operations to register the first device; determining whether or not the first device is successfully registered; based on determining that the first device is registered or based on determining that the first device is successfully registered, determining whether or not the first device is authenticated; and based on determining that the first device is authenticated, providing the first device the access to the requested service.

### TECHNICAL FIELD

Systems and methods consistent with example embodiments of the present disclosure relate to vehicle systems, and more particularly, relate to managing one or more devices in one or more vehicle systems.

### BACKGROUND

Modern vehicles are equipped with a diverse range of devices that form an interconnected vehicle system. These devices include, but are not limited to, electronic control units (ECUs), infotainment systems, sensors, actuators, telematics units, and communication modules. These devices interoperate to provide essential functions such as propulsion, safety, entertainment, connectivity, advanced driver assistance, and the like. Further, in the process of developing and manufacturing a vehicle, significant amount of devices are involved. For example, multiple fleet devices or mobile hardware may be involved in each stage of vehicle manufacturing, multiple static hardware such as servers may be utilized to store and share information, multiple testing hardware may be involved for testing a feature of the vehicle, and the like.

In this regard, the devices in the vehicle system often need to intercommunicate and share information to ensure a seamless operation and enhance user experience. However, managing these devices efficiently and securely poses significant challenges. Particularly, related art systems and approaches for managing devices of vehicle systems often lack comprehensive access management and information control capabilities, leading to various problems that need to be addressed.

To begin with, related art systems and approaches often lack robust mechanisms for identifying and authenticating devices, particularly when the devices involve different users, such as users with different roles or responsibilities, users from different teams, users from vendors, users located at different geographical locations, and the like. This can result in unauthorized or compromised devices gaining access to the system, potentially leading to security breaches or malfunctions.

Further, related art systems and approaches often lack centralized and comprehensive device information management. This can result in challenging to provide accurate information of all available devices, when the number of available devices is significant. For instance, it is difficult to comprehensively and timely identify what devices is available, where each of the devices is located, how each of the devices is connected, what is the role of each of the devices, or the like. The process for collecting and managing device information may be particularly complex when the devices are located at different geographical locations.

Furthermore, related art systems and approaches often lack granular access control mechanisms. Accordingly, it is challenging to provide appropriate information to the user. For instance, a user may be provided with a significant amount of information, which may be overwhelming and inefficient for the user to quickly grasp the desired information therefrom. Conversely, the user may be provided with inefficient amount of information, which may be less informative and the user may need to manually obtain for additional information.

In view of at least the above, there is a need to provide an improved system, method, device, and the like, to manage devices and the associated information in vehicle systems.

### SUMMARY

Example embodiments of the present disclosure provide methods, systems, and apparatuses for effectively and efficiently managing one or more devices in one or more vehicle systems.

According to embodiments, a method for managing a plurality of devices in a vehicle system is provided. The method may be implemented by at least one processor of a system and may include: obtaining, from a first device, a message for requesting a service from a second device, wherein the message comprises information of an identity (ID) of the first device; determining, based on the ID of the first device, whether or not the first device is registered; based on determining that the first device is not registered, performing one or more operations to register the first device; determining whether or not the first device is successfully registered; based on determining that the first device is registered or based on determining that the first device is successfully registered, determining whether or not the first device is authenticated; and based on determining that the first device is authenticated, providing the first device the access to the requested service. The second device may include a vault, and wherein the service is provisioning of one or more information stored in the vault. The first device and the second device may be located at different geographical locations.

According to embodiments, the determining whether or not the first device is registered may include: determining, based on the ID of the first device, whether or not a public key associated with the first device is available in one or more storage mediums of the system; based on determining that the public key of the first device is available, determining that the first device is registered; and based on determining that the public key of the first device is not available, determining that the first device is not registered.

According to embodiments, the performing the one or more operations to register the first device may include: establishing an out-of-bound (OOB) channel among the system and the first device; receiving, from the first device and through the OOB channel, information of the public key of the first device; registering the first device based on the information of the public key; and transmitting, to the first device, a result of the registering the first device. The registering the first device may include: validating the public key; and generating a mapping of the validated public key and the ID of the first device.

According to embodiments, the determining whether or not the device is authenticated may include: determining, based on the ID of the first device, whether or not the first device is authorized to utilize the requested service; based on determining that the first device is authorized to utilize the requested service, determining that the first device is authenticated; and based on determining that the first device is not authorized to utilize the requested service, determining that the first device is not authenticated.

According to embodiments, at least a portion of the message may be encrypted by the first device based on a private key, and wherein the determining whether or not the first device is authorized to utilize the requested service may include: obtaining the public key of the first device; decrypting the encrypted portion of the message to obtain the information of the requested service; and determining, based on the information of the requested service and the ID of the first device, whether or not the first device is authorized to utilize the requested service.

According to embodiments, the providing the access to the requested service may include: obtaining, from the second device, information associated with the requested service; encrypting, based on the public key of the first device, the information of the requested service obtained from the second device; and providing the encrypted information to the first device. The first device may include a trusted platform module (TPM), wherein the TPM may be configured to manage the public key and the private key, and wherein the first device may be configured to decrypt the encrypted information based on the private key.

According to embodiments, a system for managing a plurality of devices in a vehicle system is provided. The system may include: a memory storage storing computer-executable instructions and at least one processor communicatively coupled to the memory storage. The at least one processor may be configured to execute the instructions to: obtain, from a first device, a message for requesting a service from a second device, wherein the message comprises information of an identity (ID) of the first device; determine, based on the ID of the first device, whether or not the first device is registered; based on determining that the first device is not registered, perform one or more operations to register the first device; determine whether or not the first device is successfully registered; based on determining that the first device is registered or based on determining that the first device is successfully registered, determine whether or not the first device is authenticated; and based on determining that the first device is authenticated, provide the first device the access to the requested service. The second device may include a vault, and the service may include provisioning of one or more information stored in the vault. The first device and the second device may be located at different geographical locations.

According to embodiments, the at least one processor may be configured to execute the instructions to determine whether or not the first device is registered by: determining, based on the ID of the first device, whether or not a public key associated with the first device is available in one or more storage mediums of the system; based on determining that the public key of the first device is available, determining that the first device is registered; and based on determining that the public key of the first device is not available, determining that the first device is not registered.

According to embodiments, the at least one processor may be configured to execute the instructions to perform the one or more operations to register the first device by: establishing an OOB channel among the system and the first device; receiving, from the first device and through the OOB channel, information of the public key of the first device; registering the first device based on the information of the public key; and transmitting, to the first device, a result of the registering the first device. According to embodiments, the at least one processor may be configured to execute the instructions to register the first device by: validating the public key; and generating a mapping of the validated public key and the ID of the first device.

According to embodiments, the at least one processor may be configured to execute the instructions to determine whether or not the first device is authenticated by: determining, based on the ID of the first device, whether or not the first device is authorized to utilize the requested service; based on determining that the first device is authorized to utilize the requested service, determining that the first device is authenticated; and based on determining that the first device is not authorized to utilize the requested service, determining that the first device is not authenticated.

According to embodiments, at least a portion of the message may be encrypted by the first device based on a private key, and the at least one processor may be configured to execute the instructions to determine whether or not the first device is authorized to utilize the requested service by: obtaining the public key of the first device; decrypting the encrypted portion of the message to obtain the information of the requested service; and determining, based on the information of the requested service and the ID of the first device, whether or not the first device is authorized to utilize the requested service.

According to embodiments, the at least one processor may be configured to execute the instructions to provide the first device the access to the requested service by: obtaining, from the second device, information associated with the requested service; encrypting, based on the public key of the first device, the information of the requested service obtained from the second device; and providing the encrypted information to the first device. The first device may include a trusted platform module (TPM), wherein the TPM may be configured to manage the public key and the private key, and wherein the first device may be configured to decrypt the encrypted information based on the private key.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like reference numerals denote like elements, and wherein:

FIG. 1 illustrates a block diagram of an example system architecture for managing one or more devices in a vehicle system, according to one or more embodiments;

FIG. 2 illustrates a block diagram of example components of a device management system, according to one or more embodiments;

FIG. 3 illustrates a flow diagram of an example method for managing the one or more devices in the vehicle system, according to one or more embodiments;

FIG. 4 illustrates a flow diagram of an example method for registering a device in the vehicle system, according to one or more embodiments;

FIG. 5 illustrates a system configuration of an example use case for providing an access of a requested service to a device, according to one or more embodiments;

FIG. 6 illustrates a system architecture for managing one or more remote sessions among one or more user equipment (UEs) and one or more devices in the vehicle system, according to one or more embodiments; and

FIG. 7 illustrates a flow diagram of an example method for managing device information, according to one or more embodiments.

### DETAILED DESCRIPTION

The following detailed description of exemplary embodiments refers to the accompanying drawings. The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

In addition, the term “vehicle” or the like, as used herein, may refer to any motorized and/or mechanical machine which may carry or transport people and/or cargo, such as: a car, a truck, a motorcycle, a bus, a bicycle, a mobility scooter, and the like.

Example embodiments consistent with the present disclosure provide methods, systems, and apparatuses for managing one or more devices in one or more vehicle systems. Specifically, example embodiments provide a device management system (and methods for utilizing the same) which may provide centralized management of devices in a vehicle system. Accordingly, devices in the vehicle system, such as remote devices and user equipment, may be effectively and efficiently managed without manual intervention or physical visit to the devices. Ultimately, example embodiments of the present disclosure enable efficient and effective management of significant amount of devices, thereby solving the problems in the related art systems as described above.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of example embodiments of the present disclosure, as well as the associated technical advantages and significances, are provided in the following.

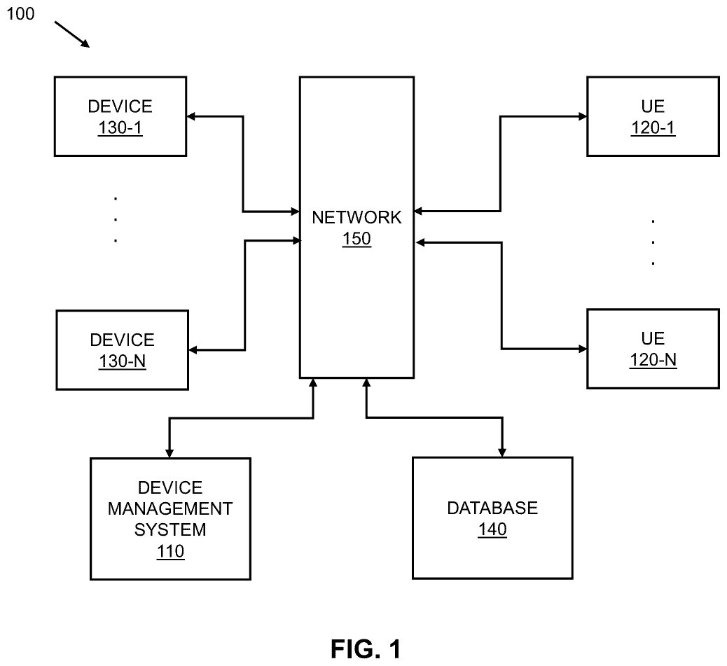

FIG. 1 illustrates a block diagram of an example system architecture 100 for managing one or more devices in a vehicle system, according to one or more embodiments. As shown in FIG. 1, the system architecture 100 may include a device management system 110, a plurality of user equipment (UEs) 120-1 to 120-N, a plurality of devices 130-1 to 130-N, a database 140, and a network 150. In this regard, it can be understood that the “one or more devices in a vehicle system” described herein may refer to one or more of the plurality of UE 120-1 to 120-N, the plurality of devices 130-1 to 130-N, and the database 140.

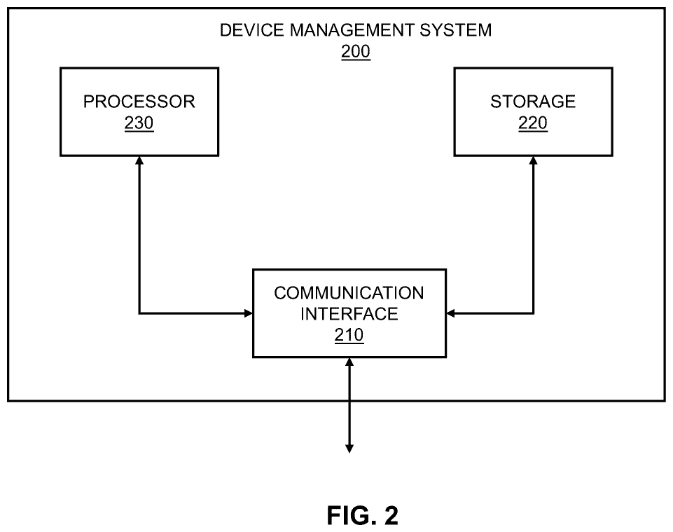

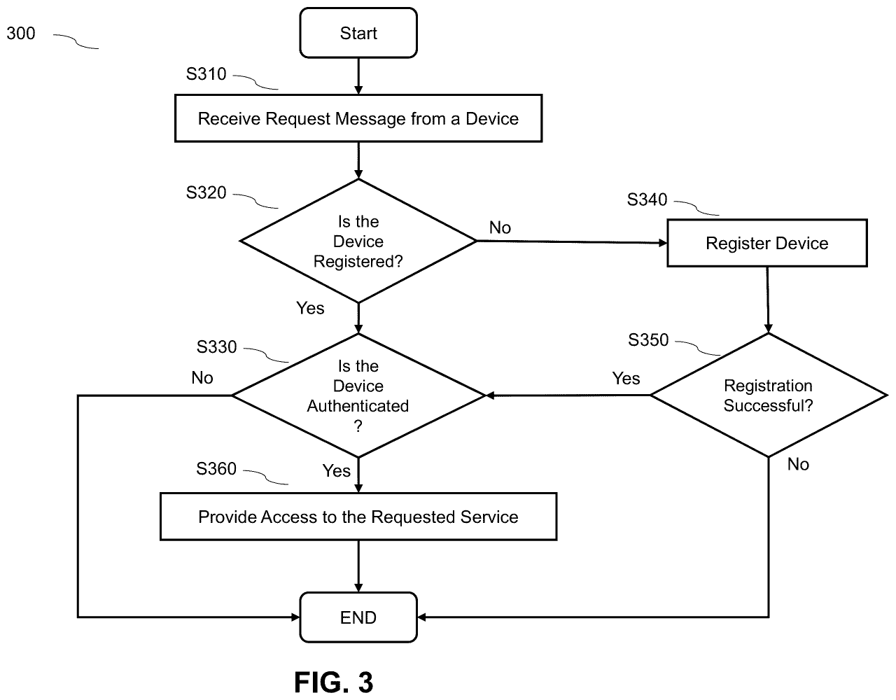

In general, the device management system 110 may be communicatively coupled to the plurality of UEs 120-1 to 120-N, the plurality of devices 130-1 to 130-N and the database 140 via the network 150, and may be configured to manage the interoperations among said devices. For instance, the device management system 110 may be configured to manage the access of the UE 120-1 to the device 130-1 and/or to the database 140, may be configured to aggregate and collet information of the devices 130-1 to 130-N, and the like. Components which may be included in the device management system 110 are described below with reference to FIG. 2, and operations which may be performed by the device management system 110 are described below with reference to FIG. 3 to FIG. 7.

The plurality of UEs 120-1 to 120-N may include one or more systems, devices, and any other suitable equipment which may be utilized by one or more users associated with one or more of the devices 130-1 to 130-N. The one or more users may include, but are not limited to, a software developer for developing software/firmware associated with one or more of the devices 130-1 to 130-N, a manager of one or more of the devices 130-1 to 130-N, the device management system 110, and/or the database 140, a vehicle manufacturer or a device vendor of one or more the devices 130-1 to 130-N, a driver/user of one or more the devices 130-1 to 130-N, and the like. The one or more users may be located at geographical locations different from one another.

The plurality of UEs 130-1 to 130-N may be utilized by the one or more associated users to access and to utilize the device management system 110. Specifically, the user(s) may access, via the associated UE, the device management system 110 to manage one or more device in the vehicle system. For instance, the user(s) may utilize, via the associated UE, the device management system 110 to search for one or more available devices, to view information of one or more available devices, to request information or service from one or more available devices, and the like. Further, the user(s) may also utilize the device management system 110 to register information associated with one or more devices, to request an access to one or more devices, to update a role of one or more users, and the like.

According to embodiments, one or more of the plurality of UEs 120-1 to 120-N may include a computing device (e.g., a desktop computer, a laptop computer, a tablet computer, a handheld computer, a smart speaker, a server, etc.), a mobile device (e.g., a smart phone, etc.), a wearable device (e.g., a pair of smart glasses or a smart watch), a SIM-based device, or any other suitable device which may be associated with the one or more users. Further, the plurality of UEs 120-1 to 120-N may include, for example, a work station, a testing system, a software development system, and the like.

According to embodiments, at least a portion of the plurality of UEs 120-1 to 120-N may be located at different geographical locations. For instance, a first portion of the plurality of UEs 120-1 to 120-N may be utilized by a first user (e.g., a developer of a software update for a first device, etc.) and the first user and the associated UE(s) may locate at a first location, while a second portion of the plurality of UEs 120-1 to 120-N may be utilized by a second user (e.g., a manager of the first device, etc.) and the second user and the associated UE(s) may locate at a second location different from the first location.

According to embodiments, the devices 130-1 to 130-N may include one or more remote devices associated with the vehicle system. In this regard, the remote devices described herein may refer to electronic components, subsystems, and/or modules that are interconnected (e.g., via network 150) and capable of communication with one or more systems (e.g., device management system 110) and one or more equipment (e.g., UE 120-1 to 120-N, database 140, etc.). These devices can include, but are not limited to:
Devices associated with control units in the vehicle, such as electronic control units (ECUs), transmission control units (TCUs), body control module (BCM) units, and the like;
Devices of vehicle infotainment systems and features, such as audio/video entertainment system, navigation system, connectivity features, user interfaces, and the like;
Telematics devices such as devices or components responsible for communication and remote monitoring of the vehicle, enabling services like remote diagnostics, vehicle tracking, and emergency assistance;
Sensor devices such as devices that collect data from various sensors, such as those related to advanced driver assistance system (ADAS), environmental monitoring, and the like.

Additionally or alternatively, the devices 130-1 to 130N may include multiple fleet devices or mobile hardware involved in each stage of vehicle manufacturing, multiple testing hardware involved for testing a feature of the vehicle, and the like.

Further, one or more of the devices 130-1 to 130-N may be located at geographical locations different from the device management system 110, from one or more of the plurality of UEs 120-1 to 120-N, and/or from the database 140. Similarly, at least a portion of the devices 130-1 to 130-N may be located at geographical locations different from another portion of the devices 130-1 to 130-N.

Referring still to FIG. 1, the database 140 may include a server, a repository, or any suitable equipment which may be configured to store data or information associated with one or more devices in the vehicle system, such as information associated with one or more services provided by the device(s), information associated with one or more users of the device(s), location information of the device(s), schedule or availability information of the device(s), resource information of the device(s), and the like. According to embodiments, the database 140 may leverage indexing and querying functionalities of database (e.g., PostgreSQL, etc.) in storing and provisioning the device information. Accordingly, the database 140 may efficiently manage and retrieve device information based on various criteria, such as device model, software/firmware information, device location, information of associated user(s), and the like.

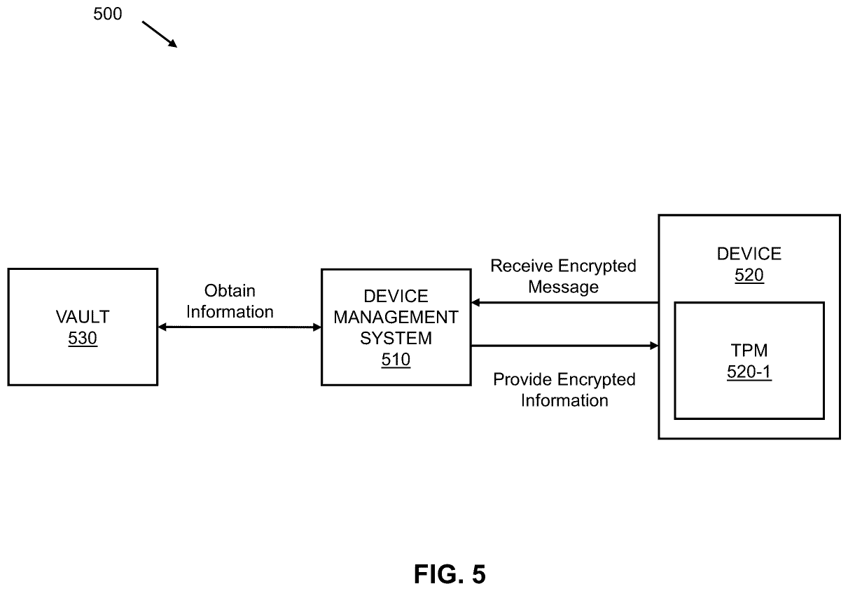

According to embodiments, the database 140 may include a vault which may include one or more repositories that serve as secure storage(s) for sensitive or privacy information within the vehicle system. The vault may employ one or more suitable encryption algorithms and access control mechanisms to safeguard the information or data stored therein. For instance, as described below with reference to FIG. 5, the vault may be configured to interoperate with a trusted platform module (TPM)-enabled device to securely provide information to the TPM-enabled device via the device management system 110. In addition to or alternative to the TPM technology, the vault may also be configured to interoperate with the device management system 110 in performing one or more role-based access control (RBAC) operations.

According to embodiments, the database 140 (e.g., a vault, etc.) may act a centralized inventory database. For instance, the database 140 may be configured to aggregate and store information of the plurality of devices 130-1 to 130-N, the information of the plurality of UE 120-1 to 120-N and/or the information of the associated users, and the like, and may be configured to appropriately provide the aggregated information when required. In this regard, the term “centralized” described herein may refer to the nature of the database 140 in collectively and centrally managing the device information, regardless of geographical locations of the devices.

Referring still to FIG. 1, the network 150 may include one or more wired and/or wireless networks, which may be configured to couple the device management system 110, the plurality of UEs 120-1 to 120-N, the plurality of devices 130-1 to 130-N, and the database 140, to one another.

For example, the network 150 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

According to embodiments, the network 150 may include a virtual network, which may include one or more physical network components (e.g., Ethernet, WiFi module, telecommunication network hardware, etc.) with one or more virtualized network functions (e.g., a control area network (CAN) bus, etc.) implemented therein.

According to embodiments, the one or more devices in the vehicle system may be interconnected to each other via the network 150, and the communication among these devices may be performed via Over-the-Air (OTA). For instance, the device management system 110 may utilize OTA capabilities to manage the interoperations among the one or more devices in the vehicle system, the database 140 may utilize OTA capabilities to collect and provide information to the one or more devices in the vehicle system, the plurality of devices 130-1 to 130-N may utilize OTA capabilities to distribute one or more services (or information associated therewith) to other devices in the vehicle system, and the like. In this way, the OTA communication between the device management system 110 and the one or more devices in the vehicle system (e.g., UE 120-1 to 120-N, devices 130-1 to 130-N, and database 140) enable information or services to be communicated in the form of data packages, thereby enabling efficient, secure, and reliable communication and information exchange.

According to embodiments, one or more device in the vehicle system (e.g., one of the plurality of the UE 120-1 to 120-N, one of the plurality of devices 130-1 to 130-N, the database 140, etc.) may include a trusted platform module (TPM). The TPM may include at least one hardware-based security component, such as a security chip, a microcontroller chip, and the like, which is integrated in the associated device(s) and is configured to provide a range of hardware-based security functions and features, including storage of security information (e.g., security keys, digital certificates, etc.), performing data encryption and/or decryption, and the like.

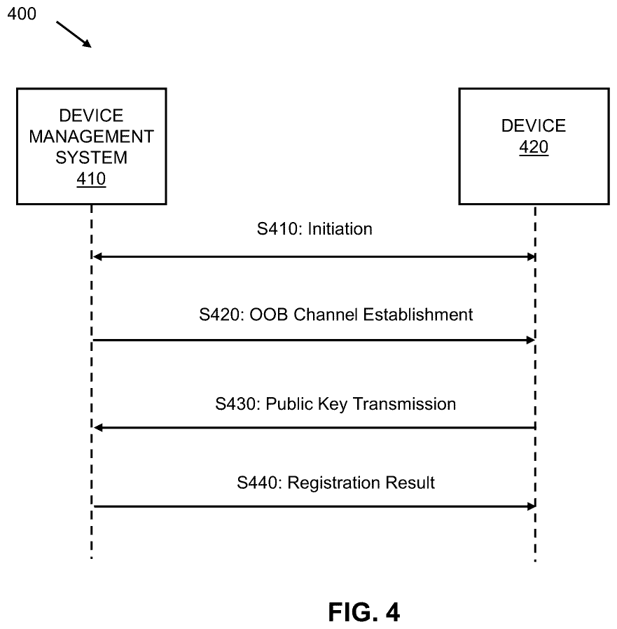

According to embodiments, the TPM of the one or more device may be configured to manage (e.g., generate, update, provide, etc.) a public-private keypair. The public-private keypair may include a pair of cryptographic keys used in asymmetric encryption (i.e., encryption that uses two separate keys, i.e., a public key and a private key, to encrypt and decrypt data or information). For instance, the public key may be used to encrypt information that can only be decrypted by the private key and the public key can be shared freely with any suitable devices within the vehicle system. The private key, on the other hand, is kept secret in the associated device and may be used to decrypt data that has been encrypted with the corresponding public key. According to embodiments, the public key may be utilized by to register the associated device to the device management system (described below with reference to FIG. 4) and the public-private keypair may be utilized by the device in accessing service or information from another device via the device management system (described below with reference to FIG. 5).

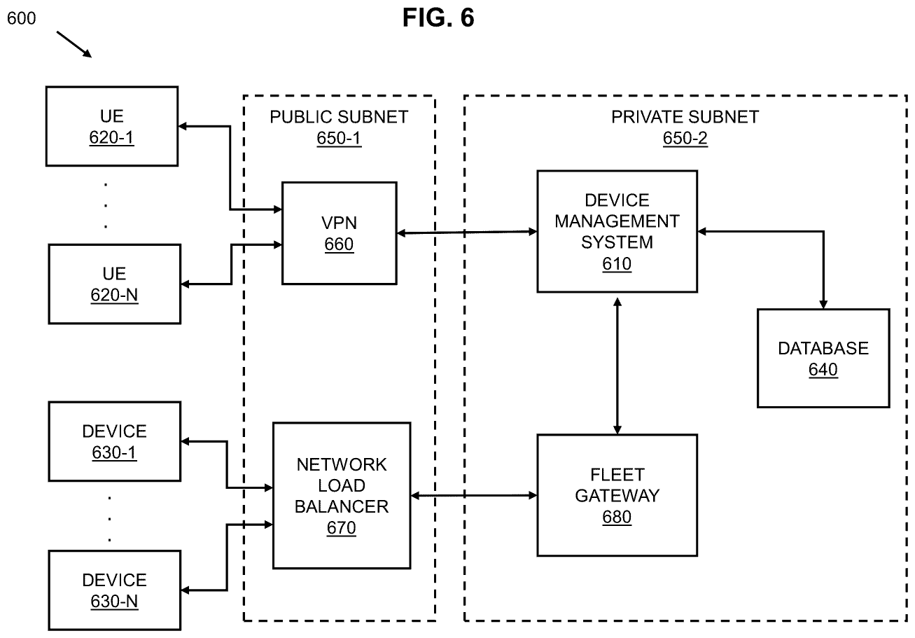

It can be understood that the components included in the system architecture 100, and the configuration thereof, described above with reference to FIG. 1 are merely example embodiments, and the system architecture may include more or less components than as described, and/or the components included therein may be arranged in any a manner different from as described, without departing from the scope of the present disclosure. For instance, as illustrated in FIG. 6, the system architecture may further include one or more fleet gateways, one or more network load balancers, and one or more virtual private networks.

FIG. 2 illustrates a block diagram of example components of a device management system 200, according to one or more embodiments. The device management system 200 may be similar to the device management system 110 in FIG. 1.

As illustrated in FIG. 2, the device management system 200 may include at least one communication interface 210, at least one storage 220, and at least one processor 230. According to embodiments, device management system 200 (or one or more components included therein) may be deployed in a server (e.g., a cloud server, a hybrid cloud server, a server cluster, etc.).

The communication interface 210 may include a transceiver-like component (e.g., a transceiver, a separate receiver and transmitter, a bus, etc.) that enables the device management system 200 (or one or more components included therein) to communicate with one or more components external to the device management system 200, such as via a wired connection, a wireless connection, or a combination of wired and wireless connections.

For instance, the communication interface 210 may couple the device management system 200 (or one or more components included therein) to a plurality of UEs (e.g., UE 120-1 to 120-N in FIG. 1, etc.), to a plurality of devices (e.g., devices 130-1 to 130-N in FIG. 1, etc.), and/or to a database (e.g., database 140 in FIG. 1, etc.), to thereby enable them to communicate and to interoperate with each. As another example, the communication interface 210 may enable the components of the device management system 200 to communicate with each other. For instance, the communication interface 210 may couple the storage 220 to the processor 230 to thereby enable them to communicate and to interoperate with each other.

According to embodiments, the communication interface 210 may include a hardware-based interface, such as a bus interface, an Ethernet interface, an optical interface, a coaxial interface, an infrared interface, a radio frequency (RF) interface, a universal serial bus (USB) interface, a Wi-Fi interface, a cellular network interface, a software interface, or the like. According to embodiments, communication interface 210 may include at least one controller area network (CAN) bus configurable to communicatively couple the components of the device management system 200 (e.g., storage 220, processor 230, etc.) to a plurality of UEs (e.g., UE 120-1 to 120-N), to a plurality of devices (e.g., devices 130-1 to 130-N), and/or to a database (e.g., database 140). Additionally or alternatively, the communication interface 210 may include a software-based interface, such as an application programming interface (API), a virtualized network interface (e.g., virtualized CAN bus, etc.), or the like.

According to embodiments, the communication interface 210 may be configured to receive information from one or more components external to the device management system 200 and to provide the same to the processor 230 for further processing and/or to the storage 220 for storing. For instance, the communication interface 210 may receive, from the plurality of UEs, one or more information associated therewith, and may provide the same to the processor 230 and/or the storage 220. Similarly, the communication interface 210 may be configured to enable the processor 230 of the device management system 200 to provide one or more information to one or more components external to the device management system 200.

Referring still to FIG. 2, the at least one storage 220 may include one or more storage mediums suitable for storing data, information, and/or computer-readable/computer-executable instructions therein. According to embodiments, the storage 220 may include a random access memory (RAM), a read only memory (ROM), and/or another type of dynamic or static storage device (e.g., a flash memory, a magnetic memory, and/or an optical memory) that stores information and/or instructions for use by the processor 230.

Additionally or alternatively, the storage 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to embodiments, the storage 220 may be configured to store information to-be utilized by the processor 230 for performing one or more operations to manage one or more updates for one or more devices. For instance, the storage 220 may be configured to store device registration information (e.g., one or more mappings of public key and device identity (ID), further described below with reference to FIG. 3 to FIG. 5, etc.), service information (e.g., one or more services provided by one or more devices in the vehicle system), user information (e.g., one or more roles of one of more users, one or more services which can be utilized by the one or more users, etc.), and the like. In some implementations, at least a portion of the information may be stored in a database (e.g., database 140).

The at least one processor 230 may be configured to receive (e.g., via the communication interface 210, etc.) one or more signals defining one or more instructions for performing one or more operations. Further, the processor 230 may be implemented in hardware, firmware, or a combination of hardware and software. The processor 230 may include a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), and/or another type of processing or computing component.

According to embodiments, the at least one processor 230 may include one or more processors capable of being programmed to perform a function or an operation for managing one or more device updates. For instance, the processor 230 may be configured to execute computer-readable instructions stored in a memory storage (e.g., storage 220, etc.) to thereby perform one or more actions or one or more operations described herein.

It can be understood that the components included in the device management system 200, and the configuration thereof, described above with reference to FIG. 2 are merely example embodiments, and the device management system 200 may include more or less components than as described, and/or the components included therein may be arranged in any a manner different from as described, without departing from the scope of the present disclosure.

For instance, according to embodiments, the device management system 200 may include an input module (e.g., a touch screen display, a button, a switch, a microphone, a sensor, a keyboard, a mouse, a joystick, a keypad, soft keys, etc.) and/or an output module (e.g., a display, a speaker, a ringer, one or more light-emitting diodes (LEDs), a LED-based display such as an active-matrix organic light-emitting diode (AMOLED) display, a thin-film transistor (TFT) display, a liquid crystal display, etc.), which may be configured to receive one or more user inputs from one or more users and/or output information to the one or more users.

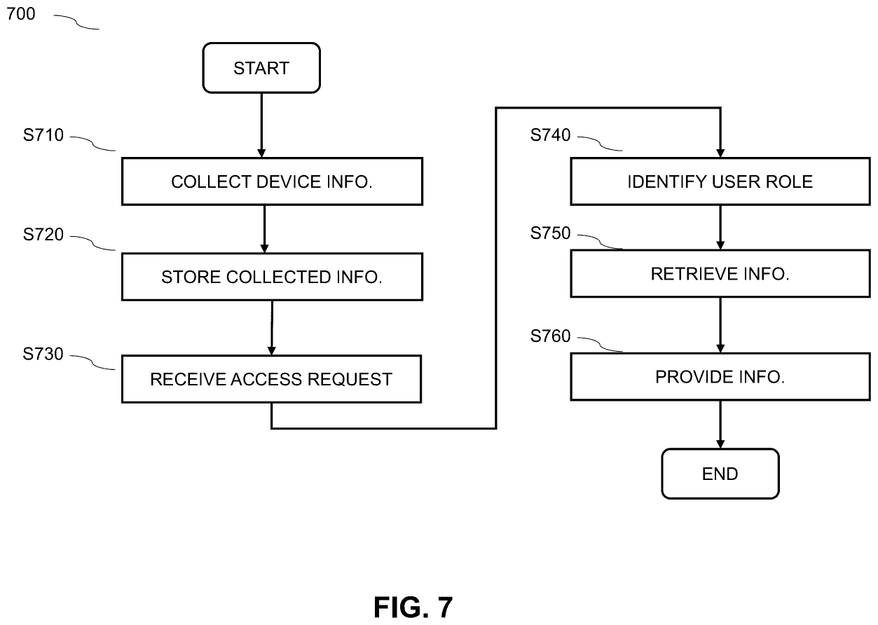

Further, according to embodiments, the device management system 200 may include a session management module, which is a dedicated module included in or associated with the processor 230 in facilitating and managing one or more sessions and coordination among the devices in the vehicle system. Descriptions of an example use case in which the device management system utilizes a session management module are provided below with reference to FIG. 6 and FIG. 7.

In view of the above, example embodiments of the present disclosure provide a device management system which may be configured to perform one or more operations for effectively and efficiently manage one or more devices in one or more vehicle systems.

FIG. 3 illustrates a flow diagram of an example method 300 for managing one or more devices in a vehicle system, according to one or more embodiments. One or more operations of method 300 may be performed by at least one processor (e.g., processor 230) of a device management system (e.g., system 110 in FIG. 1, system 200 in FIG. 2, etc.). Specifically, a memory storage (e.g., storage 220) of the device management system may store instructions (e.g., computer-readable instructions, computer-executable instructions, etc.) which, upon executed by the at least one processor, enable the at least one processor to perform one or more operations of method 300.

In general, the device management system (or the at least one processor associated therewith) may receive a message from a first device (e.g., a UE from among the plurality of UEs 120-1 to 120-N, a device among the plurality of devices 130-1 to 130-N, etc.) for requesting an access to a service from a second device (e.g., another device among the plurality of devices 130-1 to 130-N, the database 140, etc.), and may manage the access of the first device and communication of the first device and second device accordingly.

In this regard, the “service” described herein may refer to any suitable operation or service which may be implemented via communication of data or information among the devices in the vehicle system, in order to achieve one or more intended objectives. For instance, as described below with reference to FIG. 5, the first device may be a TPM-enabled device and may request sensitive information from a vault (i.e., the second device). Thus, the service being provided by the vault may refer to the provisioning of one or more information stored therein. It can be understood that any other suitable services may be implemented in a similar manner, without departing from the scope of the present disclosure.

As illustrated in FIG. 3, at operation S310, the at least one processor of the device management system may be configured to receive, from a first device, a message for requesting a service from a second device. For instance, the message may be provided by the first device via OTA and may be received by the at least one processor via a communication interface (e.g., communication interface 210). The message may include information of the requested service (e.g., title of service, time at which the service is required, etc.), information of the first device (e.g., identity (ID), subscriber number, information of a user associated with the first device, etc.), and the like.

Upon receiving the request message from the first device, the method 300 may proceed to operation S320, at which the at least one processor of the device management system may be configured to determine whether or not the first device is registered within the system. For instance, the at least one processor may determine, based on the ID of the first device (included in the request message), whether or not a public key associated with the first device is available in one or more storage mediums (e.g., storage 220) of the device management system. The public key (or information associated therewith) may be stored in the one or more storage mediums in the form of ID-public key pair or mapping.

Accordingly, based on determining that the public key of the first device is available, the at least one processor may determine that the first device is registered, and the method 300 may proceed to operation S330, at which the at least one processor may be configured to determine whether or not the first device is authenticated

Otherwise, based on determining that the public key of the first device is not available, the at least one processor may determine that the first device is not registered, and the method 300 may proceed to operation S340, at which the at least one processor may be configured to perform one or more operations to register the first device. Descriptions of example operations for registering the first device are provided below with reference to FIG. 4.

Upon performing operation 340, the method 300 may proceed to operation S350, at which the at least one processor may be configured to determine whether or not the first device is successfully registered. Based on determining that the first device is successfully registered, the method 300 may proceed to the operation S330. Otherwise, based on determining that the first device is not successfully registered, the method 300 may be terminated.

Upon determining that the first device is registered (or is successfully registered), at operation S330, the at least one processor of the device management system may be configured to determine whether or not the first device is authenticated. Specifically, the at least one processor may determine, based on the ID of the first device, whether or not the first device is authorized to utilize the requested service.

For instance, at least a portion of the request message (received by the at least one processor at operation S310) may be encrypted or signed by the first device based on a private key, and the at least one processor may obtain the public key of the first device (based on the ID of the first device) and decrypt the encrypted portion of the request message based on the public key to thereby obtain the information of the requested service. Accordingly, the at least one processor may determine (based on the role of the user associated with the first device, based on a mapping of service-allowable devices, and the like) whether or not the first device is authorized to utilize the requested service.

Accordingly, based on determining that the first device is authorized to utilize the requested service, the at least one processor may determine that the first device is authenticated, and the method 300 may proceed to operation S360, at which the at least one processor may perform one or more operations to provide to the first device an access to the requested service. Descriptions of an example use case associated therewith are provided below with reference to FIG. 5. Otherwise, based on determining that the first device is not authorized to utilize the requested service, the at least one processor may determine that the first device is not authenticated, and the method 300 may be terminated.

FIG. 4 illustrates a flow diagram of an example method 400 for registering a device in the vehicle system, according to one or more embodiments. One or more operations in method 400 may be part of operation S340 described herein with reference to FIG. 3, and may be performed by the at least one processor of the device management system. The device management system 410 in FIG. 4 may be similar to the device management system described herein with reference to other Figures, and the device 420 in FIG. 4 may be similar to the device and/or first device described herein with reference to other Figures.

In general, the device 420 may communicate with the device management system 410 to perform registration with the device management system 410. In the example of FIG. 4, the registration procedure is an Out-of-Band (OOB) registration with public key, which is a registration procedure that registers and validates the public key of the device in a secure manner. In this regard, the terms “out-of-band” may refer to the utilization of a separate and independent communication channel or method, distinct from the primary communication channel typically used for data or information exchange. In other words, when conducting OOB registration with public key, the process involves verifying the authenticity and integrity of a public key by leveraging a separate communication channel that is trusted and is secured. In this way, it can be ensured that the public key being registered in the device management system is associated with the correct device and hasn't been tampered with during transmission.

As illustrated in FIG. 4, at operation S410, the registration procedure may be initiated. For instance, the registration procedure may be initiated by the device management system 410 (or the at least one processor associated therewith), based on determining that the device 420 is not registered within the system. Additionally or alternatively, the registration procedure may be initiated by the device 420 (e.g., by sending a registration request message to the device management system 410, etc.) when the device 420 first accessing the device management system 410.

Upon initiating the registration procedure, at operation S420, the device management system 410 (or the at least one processor included therein) may establish a separated, trusted out-of-band (OOB) channel between the device management system 410 and the device 420. The OOB channel could involve physical delivery methods such as physical delivery of key material (direct inputting the public key to the device management system via input/output module of the device management system, etc.), secure messaging protocols, quick response (OR) code which includes a cryptographic key, an authentication token, a unique identifier, interactive voice response (IVR), secured email or secured file sharing, or any other secure communication channels.

Upon establishing the OOB channel, at operation S430, the device management system 410 (or the at least one processor associated therewith) may obtain or receive the public key of the device 420 via the established OOB channel. In this way, the transmission of the public key ensures that the public key reaches the device management system 410 without interception or tampering.

Upon receiving the public key, the device management system 410 may utilize the public key to register the device 420. For instance, the device management system 410 may perform validation or verification procedures to ensure the authenticity and integrity of the received public key. By way of example, the device management system 410 may perform operations such as checking digital signatures, comparing key fingerprints, or using other cryptographic techniques to validate the received public key with information associated with the device 420 and/or the user associated with the device 420.

Upon validating the public key, the device management system 410 may be configured to register the device 420 with the validated public key. For instance, the device management system may generate a mapping of the validated public key and the ID of the device 420, and may then store the mapping in one or more storage mediums (e.g., storage 220, etc.) for future utilization.

Upon registering the device 420, at operation S440, the device management system 410 may provide to the device 420 a message including the registration result, so as to notify the device 420 about the completion/termination of the registration procedure. For instance, the device management system 410 may transmit the message to the device 420 via the OOB channel. Subsequently, the device management system 410 may dismiss the OOB channel thereafter.

To this end, the device management system 410 may securely register the device 420. Upon successfully registration, the device management system 410 may provide granular access of the device 420 to various services in the vehicle system. For instance, as described in the following with reference to FIG. 5, the device management system may allow the device to communicate and exchange information or services with a second device (e.g., a vault) of the vehicle system, via the device management system.

FIG. 5 illustrates a system configuration 500 of an example use case for providing an access of a requested service to a device, according to one or more embodiments. One or more operations associated with FIG. 5 may be part of one or more operations of method 300 in FIG. 3, and may be performed by the at least one processor of the device management system. The device management system 510 may be the device management system described herein with reference to other Figures, the device 520 may be the device and/or the first device described herein with reference to other Figures, and the vault 530 may be the another device and/or the second device described herein with reference to other Figures. According to embodiments, the device 520 and the vault 530 may be located at different geographical locations and/or may be associated with different users.

In the example of FIG. 5, a first device (i.e., device 520) may request a service from a second device (i.e., vault 530) via the device management system 510. In this regard, the service may refer to the provisioning of one or more information stored in the vault 530. The device management system 510 may receive, from the device 520, an encrypted message for requesting a service from the vault 530, in a similar manner described above with reference to FIG. 3. Upon receiving the request message, the device management system 510 may determine whether or not the device 520 is registered and is authenticated before providing access to the device 520, in a similar manner described above with reference to FIG. 3. The information of the public key required in the registration procedure and authentication procedure may be generated and provided by a TPM 520-1 associated with the device 520.

In this example use case, it is assumed that the device 520 is registered and is authenticated to access the vault 530 and to utilize a service of the vault 530. Accordingly, the device management system 510 may decrypt the encrypted message based on the public key of the device 520 (stored in one or more storage mediums of the device management system 510 during the registration procedure), so as to obtain the information of the requested service therefrom. Subsequently, the device management system 510 may communicate with the vault 530 to obtain the requested information from the vault 530.

Upon obtaining the requested information, the device management system 510 (or the at least one processor associated therewith) may encrypt the obtained information with the public key associated with the device 520 and provide the encrypted service to the device 520. Upon receiving the encrypted information, the device 520 may decrypt the encrypted information to thereby utilize the requested information. For instance, the TPM 520-1 of the device 520 may be configured to decrypt the encrypted information with a private key.

It can be understood that the device management system 510 may obtain and provide any other suitable services in a similar manner, without departing from the scope of the present disclosure. In this way, the services (or information associated therewith) may be provided and shared among the devices in the vehicle system in a secured manner, and the device management system 510 may effectively provide granular access to the devices.

According to embodiments, in addition to or in alternative of utilizing the public-private keypair, the device management system may also be configured perform role-based access control (RBAC) to provide granular access of services or information to the devices in the vehicle system. For instance, the device management system may include or communicatively couple to a session management module for handling access and communication among the devices in the vehicle system. In some implementations, the session management module may be deployed in the form of computer-executable instructions or software application which, when being executed by the at least one processor of the device management system, causes the at least one processor to perform one or more operations associated with the RBAC as described herein.

According to embodiments, the device management system may leverage RBAC for user role assignment. In this regard, a user role may be associated or be assigned with a set of permissions and access rights associated with specific responsibilities or job scope of the users within the vehicle system (e.g., device manager, service provider, vendor, etc.). By leveraging RBAC, the device management system may be utilized to assign one or more roles to one or more users associated with the vehicle system, based on the responsibilities of the one or more users and/or real-time requirements. According to embodiments, one or more roles may be dynamically and temporarily assigned to one or more users. For instance, the one or more users may request or apply additional roles for a specific period of time based on specific conditions, such that the one or more users may temporary elevate privileges for specific tasks or time-limited access to certain services, devices, resources, or the like.

According to embodiments, the device management system may leverage RBAC for access permission management. For instance, the device management system may allow the definition and management of permissions associated with specific operations, services, information, or resources within the vehicle system. One or more permissions may be assigned to or mapped to one or more roles, and the users of the vehicle system may inherit these permissions according to their assigned roles. The assignment of the access permissions may be performed or managed by the manager of the vehicle system, the vehicle manufacturer, or any other trusted or any other authorized party(s).

According to embodiments, the device management system may leverage RBAC for access control policies enforcement. For instance, by leveraging RBAC, the device management system may allow the creation and enforcement of access control policies, which define conditions and rules that govern user access to the specific operations, services, information, or resources within the vehicle system. The access control policies may be managed by the manager of the vehicle system, the vehicle manufacturer, or any other trusted or any other authorized party(s), based on factors such as user roles, time-based restrictions, location-based restrictions, or any other suitable factors.

It can be understood that the device management system may be utilized for performing any other suitable RBAC operations, in addition to or in alternative of the operations described herein, without departing from the scope of the present disclosure. In view of the above, the device management system of example embodiments may perform one or more RBAC operations, in addition to or in alternative of the one or more operations of utilizing public-private keypair (described above with reference to FIG. 3 to FIG. 5), in managing the communication and interoperations of the devices in the vehicle system. By leveraging RBAC, the device management systems of example embodiments provides a flexible and scalable approach to access management within the vehicle system, and enable granular control over user permissions, simplifies administration, promotes security, and facilitates compliance with regulatory requirements.

According to embodiments, the device management system may be utilized for managing one or more remote sessions. FIG. 6 illustrates a system architecture 600 for managing one or more remote sessions among one or more user equipment (UEs) and one or more devices in a vehicle system, according to one or more embodiments.

As illustrated in FIG. 6, the system architecture 600 may include a device management system 610, a plurality of UEs 620-1 to 620-N, a plurality of devices 630-1 to 630-N, a database 640, a virtual private network (VPN) 660, a network load balancer 670, and a fleet gateway 680. The device manage system 610, the UEs 620-1 to 620-N, the devices 630-1 to 630-N, and the database 640, may be similar to those described herein with reference to one or more of FIG. 1 to FIG. 5, thus redundant descriptions associated therewith may be omitted below for conciseness.

Further, the components of system architecture 600 may be communicatively coupled to each other via a network (e.g., network 150). The network for coupling the VPN 660 and the network load balancer 670 to other components may be collectively referred to as public subnet 650-1, and the network for coupling the device management system 610, the database 640, and the fleet gateway 680 may be collectively referred to as private subnet 650-2.

In this regard, the public subnet 650-1 may be a network segment that has publicly routable IP addresses assigned to the components, while the private subnet 650-2 may be a network segment that utilizes private IP addresses that are reserved for private use within the vehicle system and are not routable on the public internet. Namely, the components of the public subnet 650-1 (i.e., the VPN 660 and the network load balancer 670) may be directly accessed by components from external network, while the components of the private subnet 650-2 (i.e., the device management system 610, the database 640, and the fleet gateway 680) may not be directly accessed by components from external network. The public subnet 650-1 and the private subnet 650-2, as well as the components associated therewith (e.g., device management system 610, database 640, VPN 660, network load balancer 670, and fleet gateway 680), may be deployed in one or more cloud computing environments.

By dividing the networks into public subnet 650-1 and private subnet 650-2, the security of the system may be enhanced since critical components like the device management system 610 and the database 640 are isolated from external components, and the public subnet 650-1 may act as an additional protection layer against external threats.

The VPN 660 in the public subnet 650-1 may act as a secure gateway, allowing the UEs 620-1 to 620-N (which may be located at different geographical locations) to connect to the public subnet 650-1 and eventually access the components of the private subnet 650-2 (e.g., device management system 610) securely over the internet. According to embodiments, the VPN 660 may provide a secure and encrypted communication channel to the UEs 620-1 to 620-N, thereby ensuring data privacy, and enabling secure access to the public subnet 650-1 from remote locations.

The database 640 may be a centralized inventory database (e.g., a vault, etc.) configured to store information of the plurality of devices 630-1 to 630-N and the plurality of UE 620-1 to 620-N. According to embodiments, the centralized inventory database may include multiple partitions, each of which may be configured to store information associated with a respective user role. For instance, the inventory database may include a first partition configured for storing device information associated with a device manager, and may include a second partition configured for storing device information associated with a maintenance engineer, or the like.

The network load balancer 670 may be a component configured to efficiently and effectively distribute network traffics across the devices 630-1 to 630-N. According to embodiments, the network load balancer 670 may be configured to monitor the status of the devices 630-1 to 630-N (e.g., hardware and/or software health status, resource availability status, etc.) and may perform one or more load balancing operations based thereon, so as to ensure optimal load distribution among the devices 630-1 to 630-N and to prevent overloading any specific device, thereby enhancing the scalability and responsiveness of the vehicle system.

The fleet gateway 680 may be a reverse proxy and/or a communication gateway which acts as an intermediary between the devices 630-1 to 630-N and the device management system 610. According to embodiments, the fleet gateway 680 may be configured to facilitate secure and encrypted communication between the devices 630-1 to 630-N and the device management system 610, so as to ensure that the information or data exchanged between the devices 630-1 to 630-N and the device management system 610 remains confidential and protected from potential security threats, such as interception and the like. Additionally or alternatively, the fleet gateway 680 may be configured to manage communication protocols, such as protocol conversion, so as to allow the devices 630-1 to 630-N (which may utilize different communication protocols) to interact with the device management system 610 seamlessly, while ensuring compatibility and interoperability between devices 630-1 and 630-N (which may have varying communication capabilities).

In view of the above, the device management system 610 may be configured to interoperate with the above described components to provide one or more remote sessions to one or more of the UEs 620-1 to 620-N for accessing or utilizing one or more of the devices 630-1 to 630-N. By leveraging the public subnet 650-1, private subnet 650-2, VPN 660, network load balancer 670, and the fleet gateway 680, the device management system 610 may provide the one or more remote sessions with enhanced security, scalability, and reliability, while at the same time ensuring smooth and seamless operation and optimal performance of the devices 630-1 to 630-N within the vehicle system.

According to embodiments, the device management system 610 may be configured to automatically collect information of the plurality of devices 630-1 to 630-N, to manage the collected device information, and to provide the collected device information to one or more users accordingly. The device management system 610 may utilize a public-private keypair and/or one or more RBAC operations, as well as one or more components in system architecture 600 (e.g., VPN 660, network load balancer 670, fleet gateway 680, etc.), as described hereinabove with reference to FIG. 1 to FIG. 6, in managing an access of a user accessing the device information.

FIG. 7 illustrates a flow diagram of an example method 700 for managing device information, according to one or more embodiments. One or more operations of the method 700 may be performed by the at least one processor of the device management system described herein. Further, one or more operations in method 700 may be similar to one or more operations described above with reference to FIG. 3 to FIG. 6, or may be performed in any suitable sequence (e.g., prior to, subsequent to, etc.) to the one or more operations described above with reference to FIG. 3 to FIG. 6.

As illustrated in FIG. 7, at operation S710, the at least one processor of the device management system may be configured to collect information from a plurality of devices (e.g., devices 130-1 to 130-N, devices 630-1 to 630-N, etc.). For instance, the at least one processor may continuously (or periodically) aggregate information of the plurality of devices via performing one or more API calls. The plurality of devices may be located at different geographical locations, and may provide the information to the at least one processor via OTA. The information may include status of the devices (e.g., hardware and/or software health status, resource status, etc.), location of the devices, information of user(s) associated with the devices, and the like.

Upon collecting the device information, the at least one processor of the device management system may be configured to store the collected device information. For instance, the at least one processor may provide the collected device information to an inventory database (e.g., database 140, database 640, etc.) to store the collected information therein. According to embodiments, the at least one processor may update one or more stored information in the inventor database with the collected information. In this way, updated information of devices available in the vehicle system may be effectively and efficiently aggregated and managed in the centralized inventory database, regardless of geographical locations of the devices.

At operation S730, the at least one processor of the device management system may be configured to receive a message for requesting an access to information associated one or more devices. The message may be provided by a UE via OTA. According to embodiments, at least a portion of the message may be signed or encrypted by the UE (e.g., based on a private key). Accordingly, the at least one processor may mange the UE (e.g., determine whether or not the UE is registered and/or is authenticated, etc.) in a similar manner described above with reference to FIG. 3 to FIG. 5. It can be understood that, in some implementations, the message may not be signed or encrypted and the method 700 may be performed without utilizing the public-private keypair, without departing from the scope of the present disclosure.

At operation S740, the at least one processor of the device management system may be configured to identify a role of a user associated with the UE. For instance, the at least one processor may obtain, based on the ID of the UE, information of the user role from one or more storage mediums (e.g., inventory database, storage within the device management system, etc.).

Upon identifying the user role, at operation S750, the at least one processor of the device management system may be configured to retrieve the requested information based on the role of the user. For instance, the request message obtained at operation S730 may indicate that the user is requesting information of a remote device, and the at least one processor may determine that the user has an admin role. Accordingly, at operation S740, the at least one processor may access the inventory database to obtain information of the remote device which are authorized to be accessed by users which has the admin role. According to embodiments, the at least one processor may access the a portion of the inventor database which is dedicated for storing and providing admin-related device information. Further, the device information may be aggregated in a historical log file which may include information showing what other users have done on the device (e.g., user access, update, configure, change location, change cabling configuration, etc.).

Upon retrieving the information, at operation S760, the at least one processor of the device management system may be configured to provide the retrieved information to the UE. For instance, the at least one processor may provide the retrieved information to the UE via OTA. According to embodiments, the at least one processor may encrypt the retrieved information with the public key of the UE and may send the encrypted information to the UE thereafter.

Alternatively or additionally, the at least one processor may be configured to include additional information to the retrieved information and provide the same to the UE. For instance, the at least one processor may assign one or more permissions for managing the retrieve information to the UE, according to the role of the user associated with the UE. By way of example, the at least one processor may provide permission or authorization for the user to view and edit the information (e.g., read and write information, etc.), to only view the information (e.g., read-only information, etc.), to share the information, and the like.

It can be understood that the device management system may be configured to manage access and communication of any suitable services, in a similar manner as described hereinabove.

In view of the above, example embodiments of the present disclosure may provide a system and a method for utilizing the same to effectively and efficiently manage one or more sessions among a plurality of UEs and a plurality of devices in a vehicle system.

To this end, example embodiments of the present disclosure provide a device management system (and a method for utilizing the same) which enable effective and efficient management of one or more devices in a vehicle system, which in turn addresses the problems in the related art as described above.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer-readable medium at any possible technical detail level of integration. Further, as described hereinabove, one or more of the above components described above may be implemented as instructions stored on a computer readable medium and executable by at least one processor (and/or may include at least one processor). The computer-readable medium may include a computer-readable non-transitory storage medium (or media) having computer-readable program instructions thereon for causing a processor to carry out operations.

The computer readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming languages such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or another device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method for managing a plurality of devices in a vehicle system, the method is implemented by at least one processor of a system and comprising:
obtaining, from a first device, a message for requesting a service from a second device, wherein the message comprises information of an identity (ID) of the first device;
determining, based on the ID of the first device, whether or not the first device is registered;
based on determining that the first device is not registered, performing one or more operations to register the first device;
determining whether or not the first device is successfully registered;
based on determining that the first device is registered or based on determining that the first device is successfully registered, determining whether or not the first device is authenticated; and
based on determining that the first device is authenticated, providing the first device the access to the requested service.

2. The method according to claim 1, wherein the determining whether or not the first device is registered comprises:
determining, based on the ID of the first device, whether or not a public key associated with the first device is available in one or more storage mediums of the system;
based on determining that the public key of the first device is available, determining that the first device is registered; and
based on determining that the public key of the first device is not available, determining that the first device is not registered.

3. The method according to claim 1, wherein the performing the one or more operations to register the first device comprises:
establishing an out-of-bound (OOB) channel among the system and the first device;
receiving, from the first device and through the OOB channel, information of the public key of the first device;
registering the first device based on the information of the public key; and
transmitting, to the first device, a result of the registering the first device.

4. The method according to claim 3, wherein the registering the first device based on the information of the public key comprises:
validating the public key; and
generating a mapping of the validated public key and the ID of the first device.

5. The method according to claim 1, wherein the determining whether or not the first device is authenticated comprises:
determining, based on the ID of the first device, whether or not the first device is authorized to utilize the requested service;
based on determining that the first device is authorized to utilize the requested service, determining that the first device is authenticated; and
based on determining that the first device is not authorized to utilize the requested service, determining that the first device is not authenticated.

6. The method according to claim 5, wherein at least a portion of the message is encrypted by the first device based on a private key, and wherein the determining whether or not the first device is authorized to utilize the requested service comprises:
obtaining the public key of the first device;
decrypting the encrypted portion of the message to obtain the information of the requested service; and
determining, based on the information of the requested service and the ID of the first device, whether or not the first device is authorized to utilize the requested service.

7. The method according to claim 6, wherein the providing the first device the access to the requested service comprises:
obtaining, from the second device, information associated with the requested service
encrypting, based on the public key of the first device, the information of the requested service obtained from the second device; and
providing the encrypted information to the first device.

8. The method according to claim 7, wherein the first device comprises a trusted platform module (TPM), wherein the TPM is configured to manage the public key and the private key, and wherein the first device is configured to decrypt the encrypted information based on the private key.

9. The method according to claim 1, wherein the second device is a vault, and wherein the service is provisioning of one or more information stored in the vault.

10. The method according to claim 1, wherein the first device and the second device are located at different geographical locations.

11. A system for managing a plurality of devices in a vehicle system, the system comprising:
a memory storage storing computer-executable instructions; and
at least one processor communicatively coupled to the memory storage, wherein the at least one processor is configured to execute the instructions to:
obtain, from a first device, a message for requesting a service from a second device, wherein the message comprises information of an identity (ID) of the first device;
determine, based on the ID of the first device, whether or not the first device is registered;
based on determining that the first device is not registered, perform one or more operations to register the first device;
determine whether or not the first device is successfully registered;
based on determining that the first device is registered or based on determining that the first device is successfully registered, determine whether or not the first device is authenticated; and
based on determining that the first device is authenticated, provide the first device the access to the requested service.

12. The system according to claim 11, wherein the at least one processor is configured to execute the instructions to determine whether or not the first device is registered by:
determining, based on the ID of the first device, whether or not a public key associated with the first device is available in one or more storage mediums of the system;
based on determining that the public key of the first device is available, determining that the first device is registered; and
based on determining that the public key of the first device is not available, determining that the first device is not registered.

13. The system according to claim 11, wherein the at least one processor is configured to execute the instructions to perform the one or more operations to register the first device by:
establishing an out-of-bound (OOB) channel among the system and the first device;
receiving, from the first device and through the OOB channel, information of the public key of the first device;
registering the first device based on the information of the public key; and
transmitting, to the first device, a result of the registering the first device.

14. The system according to claim 13, wherein the at least one processor is configured to execute the instructions to register the first device based on the information of the public key by:
validating the public key; and
generating a mapping of the validated public key and the ID of the first device.

15. The system according to claim 11, wherein the at least one processor is configured to execute the instructions to determine whether or not the first device is authenticated by:
determining, based on the ID of the first device, whether or not the first device is authorized to utilize the requested service;
based on determining that the first device is authorized to utilize the requested service, determining that the first device is authenticated; and
based on determining that the first device is not authorized to utilize the requested service, determining that the first device is not authenticated

16. The system according to claim 15, wherein at least a portion of the message is encrypted by the first device based on a private key, and wherein the at least one processor is configured to execute the instructions to determine whether or not the first device is authorized to utilize the requested service by:
obtaining the public key of the first device;
decrypting the encrypted portion of the message to obtain the information of the requested service; and
determining, based on the information of the requested service and the ID of the first device, whether or not the first device is authorized to utilize the requested service.

17. The system according to claim 16, wherein the at least one processor is configured to execute the instructions to provide the first device the access to the requested service by:
obtaining, from the second device, information associated with the requested service
encrypting, based on the public key of the first device, the information of the requested service obtained from the second device; and
providing the encrypted information to the first device.

18. The system according to claim 17, wherein the first device comprises a trusted platform module (TPM), wherein the TPM is configured to manage the public key and the private key, and wherein the first device is configured to decrypt the encrypted information based on the private key.

19. The system according to claim 1, wherein the second device is a vault, and wherein the service is provisioning of one or more information stored in the vault.

20. The system according to claim 11, wherein the first device and the second device are located at different geographical locations.
